(19) United States
(12) Patent Application Publication
(10) Pub. No.: US 2011/0281152 A1
(43) Pub. Date: Nov. 17, 2011

(54) LITHIUM-ION BATTERY PACK

(75) Inventors: XIANG-MING HE, Beijing (CN); JIAN-JUN LI, Beijing (CN); JIAN GAO, Beijing (CN); WEI-HUA PU, Beijing (CN)

(73) Assignees: HON HAI PRECISION INDUSTRY CO., LTD., Tu-Cheng (TW); TSINGHUA UNIVERSITY, Beijing (CN)

(21) Appl. No.: 12/981,540

(22) Filed: Dec. 30, 2010

(30) Foreign Application Priority Data
May 12, 2010 (CN) 201010170962.3

(51) Int. Cl. H01M 10/02

(52) U.S. Cl. 429/159

(57) ABSTRACT

The present disclosure relates to a lithium-ion battery pack. The lithium-ion battery pack comprises a plurality of battery units electrically connected with each other. The battery unit includes a positive electrode, a negative electrode, a separator, an electrolyte solution, and an external encapsulating shell. The separator is disposed between the positive electrode and the negative electrode. The positive electrode, the negative electrode, the separator, and the electrolyte solution are encapsulated in the external encapsulating shell. The positive electrode defines at least one first through-hole. The negative electrode defines at least one second through-hole. The at least one second through-holes corresponds to the at least one first through-hole.

### CROSS-REFERENCE TO RELATED APPLICATIONS

This application claims all benefits accruing under 35 U.S.C. §119 from China Patent Application No. 201010170962.3, filed on May 12, 2010, in the China Intellectual Property Office, the disclosure of which is incorporated herein by reference. This application is related to commonly-assigned applications entitled, “LITHIUM-ION BATTERY AND METHOD FOR MAKING THE SAME,” filed **** (Atty. Docket No. US33317); “LITHIUM-ION POWER BATTERY,” filed **** (Atty. Docket No. US33618); and “LITHIUM-ION STORAGE BATTERY,” filed **** (Atty. Docket No. US33617).

### BACKGROUND

1. Technical Field

The present disclosure relates to a lithium-ion battery pack.

2. Description of Related Art

A common lithium-ion battery can be a winding type or a stacked type, and includes an encapsulating shell, a positive electrode, a negative electrode, a separator, and an electrolyte solution. The positive electrode, the negative electrode, the separator, and the electrolyte solution are accommodated in the encapsulating shell. The separator is disposed between the positive electrode and the negative electrode. The electrolyte solution sufficiently infiltrates the positive electrode, the negative electrode, and the separator. The positive electrode includes a positive current collector and a positive material layer disposed on the positive current collector. The negative electrode includes a negative current collector and a negative material layer disposed on the negative collector.

The stacked type lithium-ion battery can include a plurality of positive electrodes and negative electrodes, and the positive electrodes and the negative electrodes can be alternately stacked to form a multilayered structure. The adjacent positive electrode and negative electrode are spaced by the separator. The multilayered structure can be compactly pressed together to decrease a thickness of the lithium-ion battery. Consequently, it is difficult to fill the interstices between the positive electrodes and the negative electrodes with the electrolyte solution. The larger the area of the positive electrodes and the negative electrodes, the higher the number of the stacked layers, and the more difficult it is to fill the electrolyte solution. A long period of time is often needed to allow the electrolyte solution to sufficiently infiltrate into the interstices between the positive electrodes and the negative electrodes. For example, a lithium-ion power battery stands for more than ten hours after the electrolyte solution is filled into the shell. Thus, the production efficiency of the lithium-ion power battery is low. In addition, gas produced during charging and discharging the lithium-ion battery is difficult to expel out of the lithium-ion battery because of the compactly stacked structure of the positive electrodes and negative electrodes, thereby decreasing the recycling properties of the lithium-ion battery.

What is needed, therefore, is to provide a lithium-ion battery pack that will overcome the above listed limitations.

### BRIEF DESCRIPTION OF THE DRAWINGS

Many aspects of the present disclosure can be better understood with reference to the following drawings. The components in the drawings are not necessarily to scale, the emphasis instead being placed upon clearly illustrating the principles of the present embodiments. Moreover, in the drawings, like reference numerals designate corresponding parts throughout the several views.

FIG. 1 is an external schematic view of an embodiment of a battery unit in a lithium-ion battery pack.

FIG. 2 is an internal schematic view of the battery unit of FIG. 1.

FIG. 3 is a cross-sectional view along line of the FIG. 2.

FIG. 4 is an assembly schematic view between the through-holes of positive electrode and negative electrode of the circled portion IV of FIG. 3.

FIG. 5 is a circuit view of an embodiment of a plurality of battery units electrically connected to each other in the lithium-ion battery pack.

FIG. 6 is an assembly schematic view between the plurality of battery units of FIG. 5.

FIG. 7 is a circuit view of another embodiment of a plurality of battery units electrically connected to each other in the lithium-ion battery pack.

FIG. 8 is an assembly schematic view between the plurality of battery units of FIG. 7.

FIG. 9 is a circuit view of another embodiment of a plurality of battery units electrically connected to each other in the lithium-ion battery pack.

FIG. 10 is an assembly schematic view between the plurality of battery units of FIG. 9.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

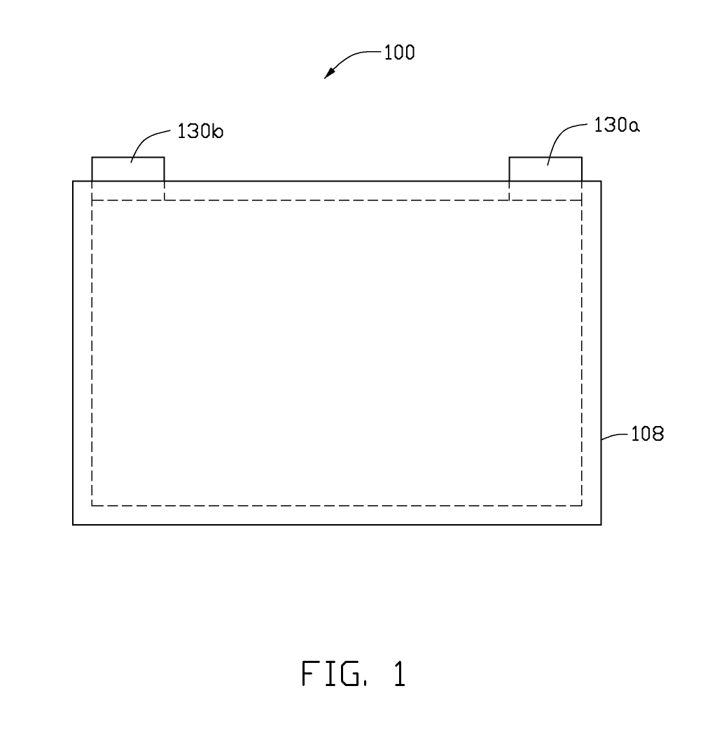

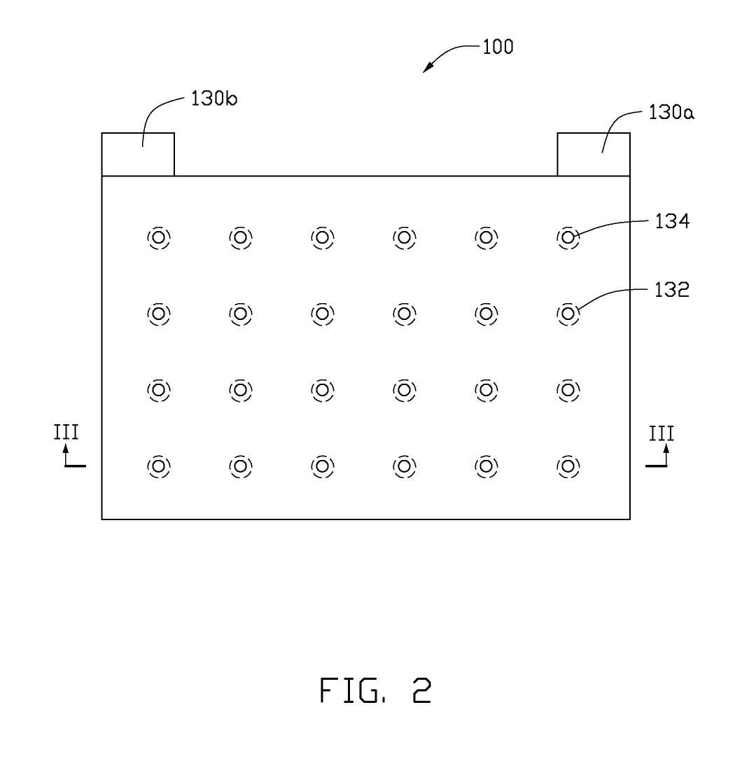

Referring to FIGS. 1 to 4, an embodiment of a lithium-ion battery pack 10 includes a plurality of battery units 100 connected in series or in parallel. The battery unit 100 includes at least one positive electrode 102, at least one negative electrode 104, at least one separator 106, a nonaqueous electrolyte solution, and an external encapsulating shell 108. The positive electrode 102, negative electrode 104, separator 106, and nonaqueous electrolyte solution are encapsulated in the encapsulating shell 108. The positive electrode 102 and the negative electrode 104 are stacked with each other and sandwiches the separator 106. The positive electrode 102 and the negative electrode 104 can be in contact with the separator 106. In one embodiment, the positive electrode 102 and the negative electrode 104 are parallel to each other. Furthermore, the battery 100 unit can include a plurality of positive electrodes 102 and a plurality of negative electrodes 104. The positive electrodes 102 and the negative electrodes 104 are alternately stacked with each other. The adjacent positive electrode 102 and the negative electrode 104 are spaced from each other by the separator 106. The number of the positive electrodes 102 and the negative electrodes 104 are not limited. For example, the battery unit 100 can include 1 to 100 layers or more of the positive electrodes 102 and the same number of layers of the negative electrodes 104. In one embodiment, the battery unit 100 includes 20 to 50 layers of the positive electrodes 102 and the same number of layers of the negative electrodes 104.

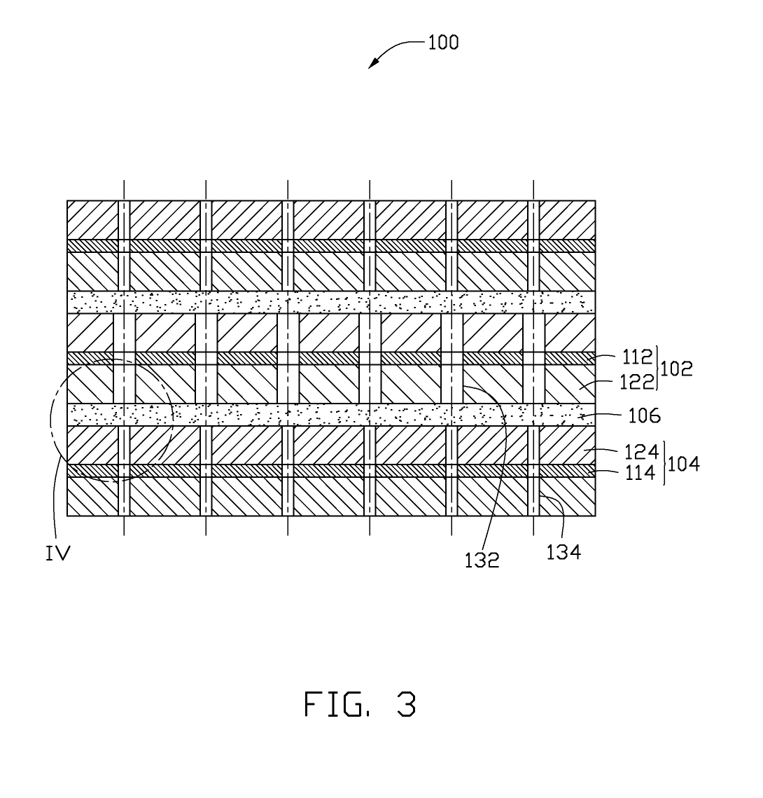

Referring to FIG. 3, each of the positive electrodes 102 includes a positive current collector 112 and at least one positive material layer 122 disposed on at least one surface of the positive current collector 112. Each of the negative electrodes 104 includes a negative current collector 114 and at least one negative material layer 124 disposed on at least one surface of the negative current collector 114. The positive material layer 122 and the negative material layer 124 face each other and sandwiches the separator 106 therebetween. The positive current collector 112 and the negative current collector 114 are sheet shaped. In one embodiment, each of the positive electrodes 102 includes two positive material layers 122 disposed on two opposite surfaces of the positive current collector 112, and each of the negative electrodes 104 includes two negative material layers 124 disposed on two opposite surfaces of the negative current collector 114. If the positive electrodes 102 and the negative electrodes 104 are stacked with each other, the adjacent positive material layer 122 and negative material layer 124 are spaced from each other by the separator 106, and attached to the separator 106.

Furthermore, the positive current collector 112 has a positive terminal tab 130a protruding from the positive material layer 122, and the negative current collector 114 has a negative terminal tab 130b protruding from the negative material layer 124. The positive terminal tab 130a of the positive current collector 112 and the negative terminal tab 130b of the negative current collector 114 are separated from each other. The positive terminal tab 130a and the negative terminal tab 130b are used to electrically connect the positive current collector 112 and the negative current collector 114 with the external circuit. If the battery units 100 include the plurality of positive electrodes 102 and the plurality of negative electrodes 104 alternately stacked with each other, the positive terminal tabs 130a of the plurality of positive current collectors 112 are overlapped with each other. The negative terminal tabs 130b of the plurality of negative current collectors 114 are also overlapped with each other.

The positive electrode 102 defines at least one first through-hole 132 through the positive current collector 112 and the positive material layer 122. The negative electrode 104 defines at least one second through-hole 134 through the negative material layer 124 and the negative current collector 114. Each second through-hole 134 is in alignment with one corresponding first through-hole 132. The first and second through-holes 132, 134 have a common axis which can be substantially perpendicular to the separator 106. The electrolyte solution is a liquid. The first through-hole 132 and the second through-hole 134 can be used as a passage for the electrolyte solution. Therefore, the electrolyte solution can infiltrate the interstices between the positive electrode 102 and the negative electrode 104 from the first through-hole 132 or the second through-hole 134, and soak the separator 106. In one embodiment, the positive electrode 102 defines a plurality of first through-holes 132 uniformly distributed, and the negative electrode 104 defines a plurality of second through-holes 134 uniformly distributed. The two opposite surfaces of the positive electrode 102 can be intercommunicated by the first through-holes 132. The two opposite surfaces of the negative electrode 104 can be intercommunicated by the second through-holes 134. The number of the first through-holes 132 and the second through-holes 134 relates to the area of the positive electrode 102 and the negative electrode 104. If a side length of the positive electrode 102 and the negative electrode 104 is less than 10 centimeters (cm), only one first through-hole 132 can be defined at a center of the positive electrode 102, and only one second through-hole 134 can be defined at a center of the negative electrode 104. If an area of each of the positive electrode 102 and the negative electrode 104 is greater than or equal to 100 cm², the plurality of first through-holes 132 can be defined in the positive electrode 102, and the plurality of second through-holes 134 can be defined in the negative electrode 104. The greater the area of the positive electrode 102 and the negative electrode 104, the larger the number of stacked layers, and the more difficult it is to fill the electrolyte solution using a conventional method. For example, if the side length of the positive electrode 102 or the negative electrode 104 is greater than or equal to about 50 cm, the electrolyte solution barely fills between the positive electrode 102 and the negative electrode 104. A plurality of first through-holes 132 can be defined in the positive electrode 102, and a plurality of second through-holes 134 can be defined in the negative electrode 104, providing a plurality of flow passages for the electrolyte solution. Therefore, the electrolyte solution can be rapidly filled in the interstices between the positive electrode 102 and the negative electrode 104, rapidly infiltrating the positive electrode 102, the negative electrode 104, and the separator 106. In addition, if the battery unit 100 includes a plurality of positive electrodes 102 and a plurality of negative electrodes 104, each of the second through-holes 134 of each of the negative electrodes 104 corresponds to one first through-hole 132 of the adjacent positive electrode 102.

Each of the second through-holes 134 of the negative electrode 104 corresponds to one first through-hole 132 of the positive electrode 102. The number of the first through-holes 132 of the positive electrode 102 can be larger than or equal to the number of the second through-holes 134 of the negative electrode 104. In one embodiment, the number of the first through-holes 132 is equal to the number of the second through-holes 134. In addition, the separator 106 should not define any hole to avoid a short circuit between the positive electrode 102 and the negative electrode 104.

The shape of the first through-holes 132 and the second-holes 134 are not limited, and can be round, square, rhombic, triangular, or any combination thereof. The shape of the first through-holes 132 can be the same as that of the corresponding second-holes 134. For example, if the shape of the first through-holes 132 is round, the shape of the second through-holes 134 corresponding to the first through-holes 134 is also round. The area of each of the first through-holes 132 and the second through-holes 134 can be in a range from about 0.001 square millimeters (mm²) to about 13 mm² The side length or diameter of each of the first through-holes 132 and the second through-holes 134 can be in a range from about 50 micrometers (μm) to about 4 mm. In one embodiment, the first through-holes 132 and the second through-holes 134 are round in shape having a diameter in a range from about 1 mm to about 2 mm. A distance between the axes of the adjacent first through-holes 132 of the same positive electrode 102 is in a range from about 1 cm to about 50 cm. A distance between the axes of the adjacent second through-holes 134 of the same negative electrode 104 is in a range from about 1 cm to about 50 cm. In one embodiment, the distance is about 5 cm. The plurality of first through-holes 132 defined by the same positive electrode 102 can be arranged in rows to form an array, or arranged radially around the center of the positive electrode 102. The plurality of second through-holes 134 defined by the same negative electrode 104 can be arranged in rows to form an array, or arranged radially around the center of the negative electrode 104. An opening ratio of the through-holes is a ratio of the total area of the through-holes in a surface to the total area of the surface. Each of the opening ratio of the first through-hole 132 of the positive electrode 102 and the opening ratio of the second through-hole 134 of the negative electrode 104 can be less than 10%, in one embodiment, less than 2% (e.g. in a range of 1% to 2%). The smaller the opening ratio, the more active material the positive current collector 112 and the negative current collector 114 can carry, thereby avoiding a capacity loss of the battery unit 100. Further, the small opening ratio can provide enough strength to the positive current collector 112 and the negative current collector 114.

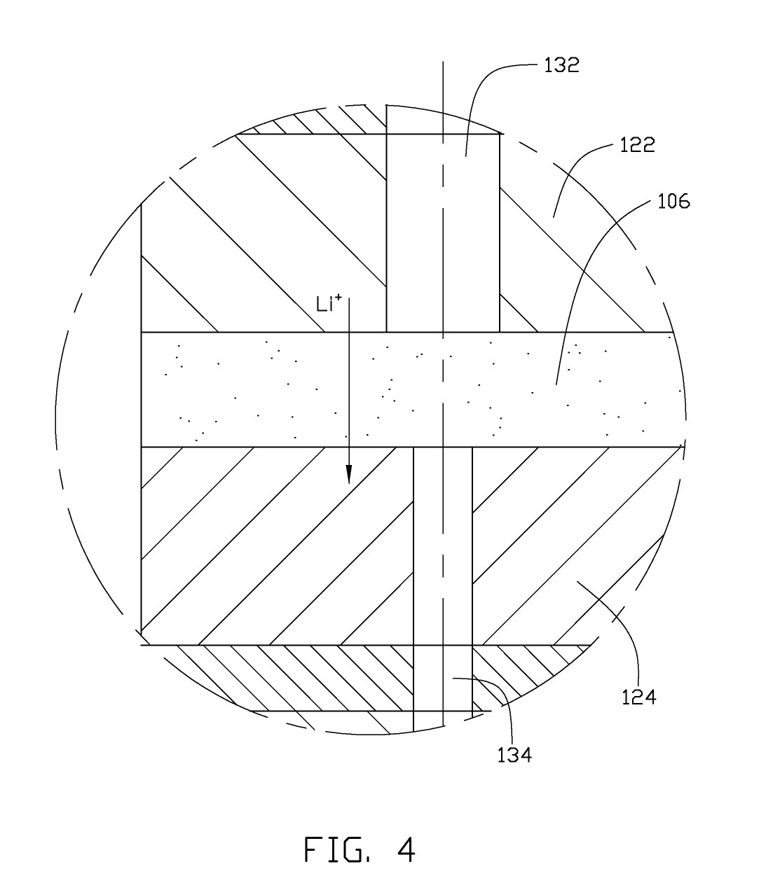

Referring to FIG. 4, the size of the first through-hole 132 of the positive electrode 102 can be larger than or equal to a size of the second through-hole 134 of the negative electrode 104. If the first through-hole 132 and the second through-hole 134 are round in shape, the diameter of the first through-hole 132 can be larger than or equal to the diameter of the second through-hole 134. If the first through-hole 132 and the second through-hole 134 are square in shape, the side length of the first through-hole 132 can be larger than or equal to the side length of the second through-hole 134. In one embodiment, the size of the first through-hole 132 is larger than that of the second through-hole 134 to retain a fitting allowance for assembling the positive electrode 102 and the negative electrode 104 together. The positive electrode 102 and the negative electrodes are parallel to each other. If the axis of the first through-hole 132 and the axis of a corresponding second through-hole 134 are not exactly coaxial, the first through-hole 132 can still encompass the second through-hole 134 from a view at a direction substantially perpendicular to the axes of the positive electrode 102 and the negative electrode 104. Namely, a projection of the second through-hole 134 is located in a projection of the first through-hole 132, along a direction substantially perpendicular to the negative electrode 104. Thus, the entire positive material layer 122 of the positive electrode 102 is totally fall in the negative material layer 124 of the negative electrode 104 along the direction substantially perpendicular to the negative electrode 104, thereby avoiding a precipitation of the lithium atoms from the positive material layer 122, and improving the safety of the lithium-ion power battery 100. The side length or diameter of the first through-holes 132 can be in a range from about one and a half to about twice of the side length or diameter of the second through-holes 134. In one embodiment, the side length or diameter of the first through-holes 132 is about 2 mm, and the side length or diameter of the second through-holes 134 is about 1 mm. If the battery unit 100 includes a plurality of positive electrodes 102 and a plurality of negative electrodes 104 stacked with each other, the axes of the first through-holes 132 of the plurality of positive electrodes 102 can be aligned with the axes of the corresponding second through-holes 134 of the plurality of negative electrodes 104, or the first through-holes 132 of the plurality of positive electrodes 102 can cover the second through-holes 134 of the plurality of positive electrodes 104 along a direction substantially perpendicular to the positive electrodes 102 and the negative electrodes 104.

The positive current collector 112 and the negative current collector 114 can be made of metal foil. In some embodiments, the positive current collector 112 can be titanium foil or aluminum foil. The negative current collector 114 can be copper foil or nickel foil. A thickness of each of the positive current collector 112 and the negative current collector 114 can be in a range from about 1 μm to about 200 μm. The positive material layer 122 includes a mixture containing positive active material, conductive agent, and adhesive uniformly mixed together. The negative material layer 124 includes a mixture containing negative active material, conductive agent, and adhesive uniformly mixed together. The positive active material can be lithium manganate (LiMn₂O₄), lithium cobalt oxide (LiCoO₂), lithium nickel oxide (LiNiO₂), or lithium iron phosphate (LiFePO₄). The negative active material can be natural graphite, pyrolysis carbon, or mesocarbon microbeads (MCMB). The conductive agent can be acetylene black or carbon fiber. The adhesive can be polyvinylidene fluoride (PVDF) or polytetrafluoroethylene (PTFE). A thickness of the positive electrode 102 can be in a range from about 100 μm to about 300 μm, and a thickness of the negative electrode 104 can be in a range from about 50 μm to about 200 μm. In one embodiment, the thickness of the positive electrode 102 is about 200 μm, and the thickness of the negative electrode 104 is about 100 μm.

The separator 106 can be a polypropylene microporous film. The electrolyte solution includes an electrolyte and an organic solvent. The electrolyte can be lithium hexafluorophosphate (LiPF₆), lithium terafluoroborate (LiBF₄), lithium bis(oxalato)borate (LiBOB), or combinations thereof. The organic solvent can be ethylene carbonate (EC), diethyl carbonate (DEC), dimethylcarbonate (DMC), ethylmethyl carbonate (EMC), propylene carbonate (PC), or combinations thereof. In addition, the electrolyte solution can be substituted with solid electrolyte film or ionic liquid. If the electrolyte solution is substituted with solid electrolyte film, the separator 106 is also substituted by the solid electrolyte film disposed between the positive material layer 122 and the negative material layer 124.

The external encapsulating shell 108 can be a rigid battery shell or a soft encapsulating bag. The positive terminal tab 130a and the negative terminal tab 130b are exposed to outside of the external encapsulating shell 108, thereby connecting the external circuit.

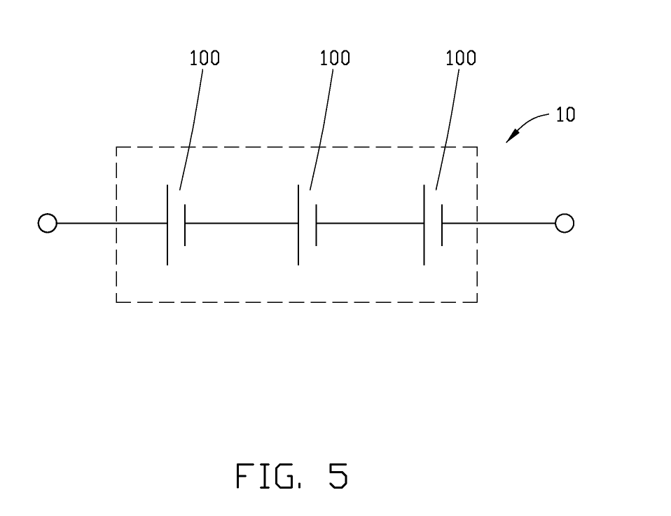

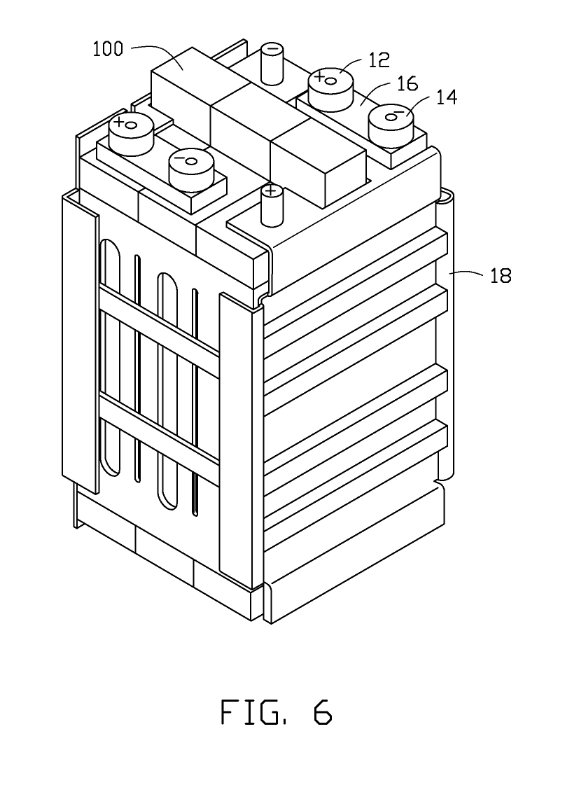

Referring to FIGS. 5 and 6, in one embodiment, the lithium-ion battery pack 10 includes a plurality of battery units 100 connected in series. Each of the battery units 100 can include a positive terminal 12 and a negative terminal 14. The positive terminal 12 can be electrically connected with the positive terminal tab 130a of the battery unit 100, the negative terminal 14 can be electrically connected with the negative terminal tab 130b of the battery unit 100. The plurality of battery units 100 can be stacked with each other. The positive terminals 12 and the negative terminals 14 of the plurality of battery units 100 stacked with each other can be alternately arranged. Namely, one positive terminal 12 of one battery unit 100 can be adjacent to one negative terminal 14 of another battery unit 100, thereby conveniently connecting the plurality of battery units 100 in series.

Furthermore, the lithium-ion battery pack 10 can include a plurality of connecting sheets 16 and a fastener 18. Each of the connecting sheets 16 can be used to electrically connect one positive terminal 12 of a battery unit 100 with one negative terminal 14 of another adjacent battery unit 100. The fastener 18 can be used to fix the plurality of battery units 100 together. The fastener 18 can be disposed on a periphery and underside of the plurality of battery units 100, thereby avoiding motion or dislocations between the battery units 100.

The number of the plurality of battery units 100 is not limited. In one embodiment, the lithium-ion battery pack 10 includes three battery units 100 connected in series. A voltage of the lithium-ion battery pack 10 can be increased by connecting the plurality of battery units 100 in series. If an operating voltage of one battery unit 100 is V₀, and the lithium-ion battery pack 10 includes a plurality of battery units 100 connected in series, the total voltage V of the lithium-ion battery pack 10 can be calculated by the formula of V=V₀×n, wherein n represents the number of the battery units 100.

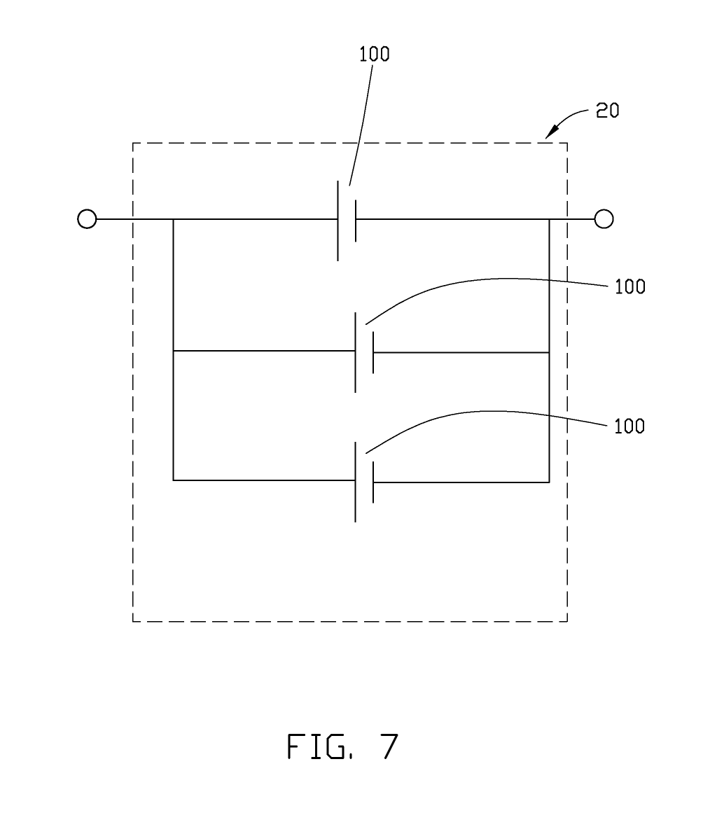

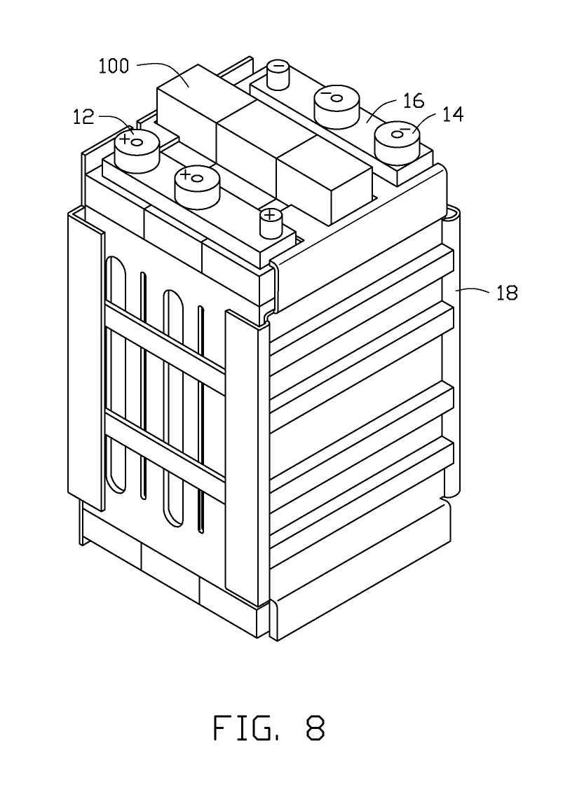

Referring to FIGS. 7 and 8, in one embodiment, a lithium-ion battery pack 20 includes a plurality of battery units 100 connected in parallel, a plurality of connecting sheets 16, and a fastener 18. Each of the battery units 100 can include a positive terminal 12 and a negative terminal 14. A difference between the lithium-ion battery pack 20 and the lithium-ion battery pack 10 is that the positive terminals 12 of the plurality of battery units 100 are adjacent to each other, and the negative terminals 14 of the plurality of battery units 100 are adjacent to each other, thereby conveniently connecting the plurality of battery units 100 in parallel.

The number of the plurality of battery units 100 is not limited. In one embodiment, the lithium-ion battery pack 20 includes three battery units 100 connected in parallel. A capacity of the lithium-ion battery pack 20 can be increased by connecting the plurality of battery units 100 in parallel. When the capacity of one battery unit 100 is C₀, and the lithium-ion battery pack 20 includes a plurality of battery units 100 connected in parallel, the capacity C of the lithium-ion battery pack 20 can be calculated by the formula of C=C₀×n, wherein n represents the number of the battery units 100.

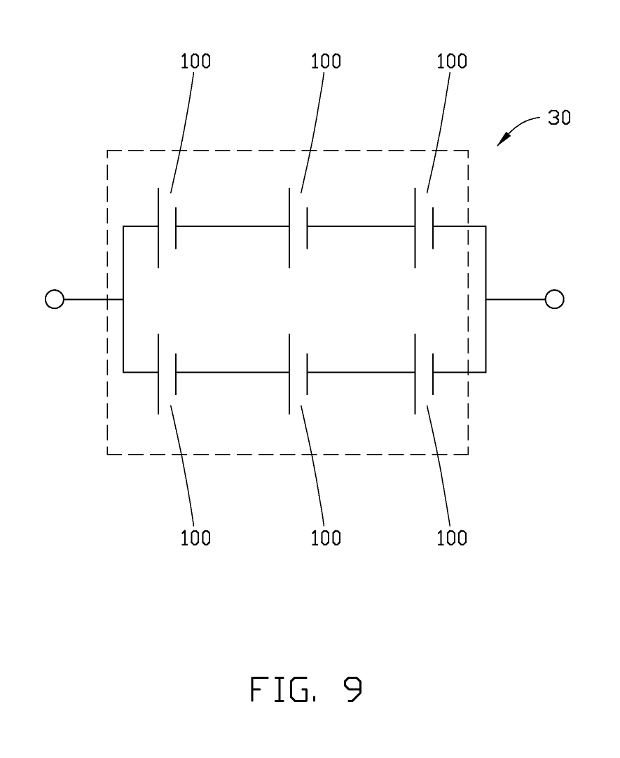

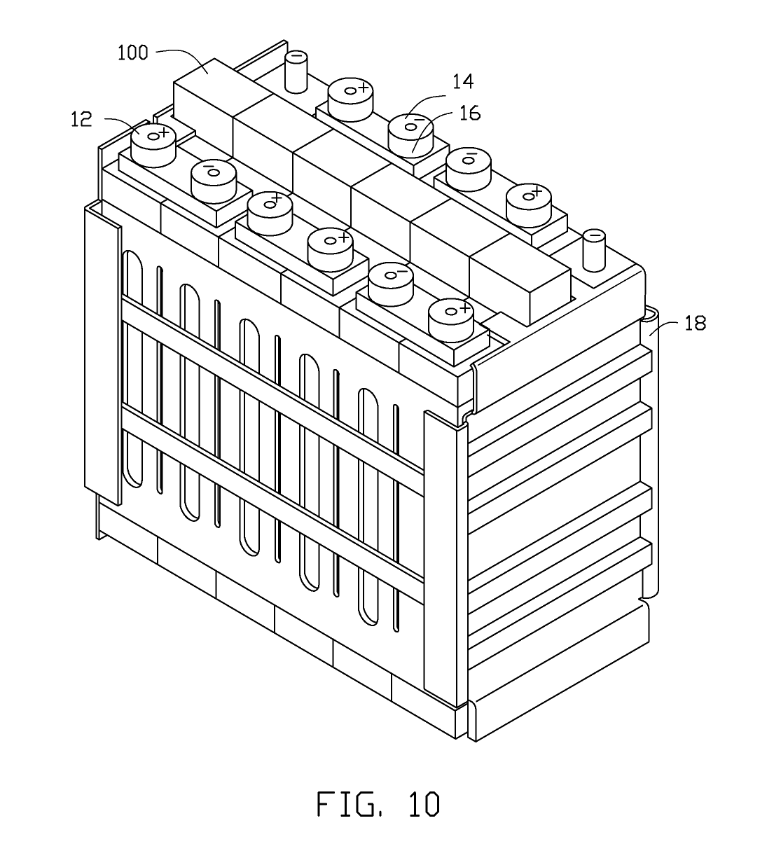

Referring to FIGS. 9 and 10, in one embodiment, a lithium-ion battery pack 30 includes a plurality of battery groups connected in parallel. Each of the battery groups includes a plurality of battery units 100 connected in series, a plurality of connecting sheets 16, and a fastener 18. The number of the battery units 100 connected in series of each of the battery groups can be the same. Each of the battery units 100 can include a positive terminal 12 and a negative terminal 14. In each of the battery groups, one positive terminal 12 of one battery unit 100 can be adjacent to one negative terminal 14 of another battery unit 100, thereby conveniently connecting the plurality of battery units 100 in series. One positive terminal 12 of one battery group can be adjacent to one positive terminal 12 of another adjacent battery group, and one negative terminal 14 of one battery group can be adjacent to one negative terminal 14 of another adjacent battery group, thereby conveniently connecting the plurality of battery groups in parallel.

The number of the battery units 100 is not limited. In one embodiment, the lithium-ion battery pack 30 includes two battery groups connected in parallel, each of the battery groups includes three battery units 100 connected in series. The total voltage and the total capacity of the lithium-ion battery pack 10 can be increased by connecting the plurality of battery units 100 in series to form a plurality of battery groups, and connecting the plurality of battery groups in parallel. If the capacity of one battery unit 100 is C₀, and the voltage of the battery unit 100 is V₀, the total capacity C of the lithium-ion battery pack 30 can be calculated by the formula of C=C₀×m, the total voltage V of the lithium-ion battery pack 30 can be calculated by the formula of V=V₀×n, wherein m represents the number of the battery groups connected in parallel, n represents the number of the battery units connected in series in one battery group.

In addition, the plurality of battery units 100 can be connected with each other by other methods. For example, the plurality of battery units 100 can be in parallel to form the battery group, and a plurality of battery groups can be further in series. Furthermore, the lithium-ion battery pack can be connected with other circuit components such as capacitors, resistors, or inductors.

A method for making the battery unit 100 of the lithium-ion battery pack includes the following steps:

S1, providing a positive current collector 112 and a negative current collector 114;

S2, coating a positive material layer 122 on the positive current collector 112 to form a positive electrode 102, and coating a negative material layer 124 on the negative current collector 114 to form a negative electrode 104;

S3, defining at least one first through-hole 132 in the positive electrode 102, and at least one second through-hole 134 in the negative electrode 104, wherein a position of the first through-hole 132 corresponds to a position of the second through-hole 134; and

S4, encapsulating the positive electrode 102 and the negative electrode 104 in the external encapsulating shell 108.

In the step S2, the positive material layer 122 and the negative material layer 124 can be fabricated by the following sub-steps of: S21, mixing the positive active material, the conductive agent, and the adhesive solution together, thereby forming a positive slurry, and mixing the negative active material, the conductive agent, and the adhesive solution together, thereby forming a negative slurry; S22, coating the positive slurry on the positive current collector 112 using a coating machine, drying the positive slurry thereby forming the positive material layer 122 on the positive current collector 112, coating the negative slurry on the negative current collector 114 using the coating machine, and drying the negative slurry thereby forming the negative material layer 124 on the negative current collector 114. Furthermore, in step S22, the positive material layer 122 and the negative material layer 124 can be compactly pressed together using a laminator.

In step S3, the first through-hole 132 and the second through-hole 134 can be formed by punching, impact molding, or laser etching. The laser etching can form a small size of the first through-hole 132 and the second through-hole 134. The first through-hole 132 is formed after coating the positive material layer 122 to avoid being blocked by the positive slurry. The second through-hole 134 is formed after the coating of the negative material layer 124 to avoid being blocked by the negative slurry. The first through-hole 132 and the second through-hole 134 can be a one to one correspondence. Specifically, the size of the positive electrode 102 is the same as the size of the negative electrode 104, and the positive electrode 102 and the negative electrode 104 can be located together by a locating device. The first through-hole 132 and the second through-hole 134 are simultaneously formed.

If the battery unit 100 includes the electrolyte solution or ionic liquid, the above step S4 further includes the following sub-steps of:

S41, providing the separator 106, and disposing the separator 106 between the positive electrode 102 and the negative electrode 104, thereby forming a laminate structure;

S42, pressing the laminate structure using a laminator;

S43, filling the electrolyte solution or the ionic liquid between the positive electrode 102 and the negative electrode 104 from the first through-hole 132 or the second through-hole 134.

In step S41, the separator 106 can be first disposed on a surface of the positive electrode 102, and the negative electrode 104 is then disposed on the separator 106. In the assembling process, the first through-hole 132 of the positive electrode 102 is aligned with the second through-hole 134 of the negative electrode 104. In addition, the lithium-ion power battery 100 can include a plurality of laminate structures overlapping each other.

In step S43, the first through-hole 132 and the second through-hole 134 can form a flowing passage for the electrolyte solution or the ionic liquid. Therefore, the electrolyte solution or the ionic liquid can flow rapidly between the positive electrode 102 and the negative electrode 104, thereby rapidly infiltrating the positive electrode 102, the negative electrode 104, and the separator 106, and improving the production efficiency of the lithium-ion battery pack. The larger the area of the positive electrode 102 and the negative electrode 104, the more obvious the effect of the first through-holes 132 and the second through-holes 134. The area of the positive electrode 102 and the negative electrode 104 can be larger than 400 cm². If the positive electrode 102 and the negative electrode 104 are square, the side length of the positive electrode 102 and the negative electrode 104 can be larger than 10 cm. In one embodiment, the side length of the positive electrode 102 and the negative electrode 104 is in a range from about 20 cm to about 100 cm.

If the solid electrolyte is substituted with electrolyte solution or the ionic liquid, the solid electrolyte can be used as the separator 103 disposed between the positive electrode 102 and the negative electrode 104.

In use, a gas generated by the electrolyte or other element can easily expelled out from the first through-hole 102 and the second through-hole 104.

Depending on the embodiment, certain steps of the methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A lithium-ion battery pack comprising a plurality of battery units electrically connected with each other, each of the plurality of battery units comprising a positive electrode and a negative electrode stacked with and spaced from each other, the positive electrode defining at least one first through-hole, the negative electrode defining at least one second through-hole, wherein the at least one second through-hole corresponds to the at least one first through-hole.

2. The lithium-ion battery pack as claimed in claim 1, wherein the at least one first through-hole comprises a plurality of first through-holes, the at least one second through-hole comprises a plurality of second through-holes, and each of the plurality of second through-holes corresponds to one of the plurality of first through-holes.

3. The lithium-ion battery pack as claimed in claim 2, wherein a distance between axes of adjacent first through-holes, or a distance between axes of adjacent second through-holes is in a range from about 1 cm to about 50 cm.

4. The lithium-ion battery pack as claimed in claim 3, the axes of the first through-holes is substantially aligned with the axes of the second through-holes.

5. The lithium-ion battery pack as claimed in claim 2, wherein each of the plurality of first through-holes is round in shape and has a diameter of 2 mm, each of the plurality of second through-holes is round in shape and has a diameter of 1 mm, and an axis of each of the plurality of first through-holes is substantially aligned with an axis of one second through-hole.

6. The lithium-ion battery pack as claimed in claim 5, wherein a distance between the axes of adjacent first through-holes and a distance between the axes of adjacent second through-holes are both about 5 cm.

7. The lithium-ion battery pack as claimed in claim 1, wherein a shape of the at least one first through-hole is the same as a shape of the at least one second through-hole.

8. The lithium-ion battery pack as claimed in claim 1, wherein an area of the at least one first through-hole is larger than an area of the at least one second through-hole.

9. The lithium-ion battery pack as claimed in claim 1, wherein the positive electrode and the negative electrode are substantially parallel to each other, a projection of the at least one second through-hole along a direction substantially perpendicular to the negative electrode is surrounded by a projection of the at least one first through-hole along a direction substantially perpendicular to the negative electrode.

10. The lithium-ion battery pack as claimed in claim 1, wherein a shape of the at least one first through-hole and the at least one second-hole is round, square, rhombic, or triangular.

11. The lithium-ion battery pack as claimed in claim 1, wherein an area of each of the at least one first through-hole and the at least one second through-hole are each in a range from about 0.001 mm² to about 13 mm².

12. The lithium-ion battery pack as claimed in claim 1, wherein an opening ratio of the positive electrode or the negative electrode is less than 10%.

13. The lithium-ion battery pack as claimed in claim 1, wherein the positive electrode comprises a positive current collector and at least one positive material layer disposed on at least one surface of the positive current collector, and the negative electrode comprises a negative current collector and at least one negative material layer disposed on at least one surface of the negative current collector.

14. The lithium-ion battery pack as claimed in claim 1, wherein each of the plurality of battery units further comprises a separator disposed between the positive electrode and the negative electrode.

15. The lithium-ion battery pack as claimed in claim 14, wherein each of the plurality of battery units further comprises electrolyte solution or ionic liquid, and an external encapsulating shell, wherein the positive electrode, the negative electrode, the separator, and the electrolyte solution or ionic liquid are encapsulated in the external encapsulating shell.

16. The lithium-ion battery pack as claimed in claim 1, further comprising solid electrolyte film disposed between the positive electrode and the negative electrode.

17. The lithium-ion battery pack as claimed in claim 1, further comprising a plurality of connecting sheets and a fastener, and each of the plurality of battery units comprises a positive terminal and a negative terminal, the positive terminal is electrically connected with the positive electrode, the negative terminal is electrically connected with the negative electrode, and the plurality of battery units are electrically connected with each other by the plurality of connecting sheets and fixed by the fastener.

18. The lithium-ion battery pack as claimed in claim 1, wherein the plurality of battery units is connected with each other in series, in parallel, or a combination thereof.

19. A lithium-ion battery pack comprising a plurality of battery units electrically connected with each other, each of the plurality of battery units comprising a plurality of positive electrodes and a plurality of negative electrodes alternately overlapped with and spaced from each other, wherein each of the plurality of positive electrodes defines a plurality of first through-holes, each of the plurality of negative electrodes defines a plurality of second through-holes, and each of the plurality of second through-holes corresponds to one first through-hole.

20. The lithium-ion battery pack as claimed in claim 19, wherein the plurality of first through-holes of each of the plurality of positive electrodes and the plurality of second through-holes of each of the plurality of negative electrodes are one to one correspondence.
